(19) United States
(12) Patent Application Publication
(10) Pub. No.: US 2024/0037124 A1
(43) Pub. Date: Feb. 1, 2024

(54) TRANSFORMING DATA VISUALIZATIONS DURING PAGE TRANSITIONS

(71) Applicant: Intuit Inc., Mountain View, CA (US)

(72) Inventors: Samuel Austin SMITH, Trophy Club, TX (US); Beverly CHOU, San Francisco, CA (US)

(73) Assignee: Intuit Inc., Mountain View, CA (US)

(21) Appl. No.: 17/875,609

(22) Filed: Jul. 28, 2022

(51) Int. Cl. G06F 16/28; G06F 16/25; G06F 16/248

(52) U.S. Cl. CPC G06F 16/287; G06F 16/252; G06F 16/248

(57) ABSTRACT

Systems and methods for transforming a data visualization are disclosed. An example method includes presenting the data visualization on a first page of a display of the computing device, the data visualization representing at least a first portion of a data set, receiving a visualization transformation command from a user, in response to receiving the visualization transformation command, navigating to a second page of the display, and, during the navigation, transforming the data visualization based at least in part on the first portion of the data set, wherein the transformation includes at least enlarging the data visualization and rotating the data visualization from a first orientation to a second orientation.

### TECHNICAL FIELD

This disclosure relates generally to user interfaces, and more particularly to improving the utility, flexibility, and continuity of data visualizations across multiple pages of a user interface.

### DESCRIPTION OF RELATED ART

Mobile electronic devices, such as cellular phones, tablets, and so on, may switch a display orientation in response to detection of a rotation of the device, such as switching between a portrait display orientation where the display is taller than it is wide, and a landscape display orientation, where the display is wider than it is tall. The mobile electronic device may automatically adjust contents of its display in response to switching its display orientation, so that the contents of the display, including text, graphics, and so on, are adjusted to better fit the new display orientation.

Further, companies and individuals increasingly provide tools for visualizing data associated with a wide variety of purposes. For example, such data may include demographic data, inventory data, polling data, transaction data, account data, and so on. Data visualizations may be useful for providing such data to users in an accessible and interactive manner. Applications for providing such visualizations may include a number of related pages for providing such data to users.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for transforming a data visualization. An example method includes presenting the data visualization on a first page of a display of the computing device, the first data visualization representing at least a first portion of a data set, receiving a visualization transformation command from a user, in response to receiving the visualization transformation command, navigating to a second page of the display, and, during the navigation, transforming the data visualization based at least in part on the first portion of the data set, wherein the transformation includes at least enlarging the data visualization and rotating the data visualization from a first orientation to a second orientation.

In some aspects, the first page and the second page share a common orientation. In some aspects, the transforming includes adding one or more layers to the data visualization. In some aspects, the one or more added layers are based at least in part on the first portion of the data set. In some aspects, the transforming includes adding one or more animations to the transformed data visualization, the one or more animations absent from the data visualization presented on the first page. In some aspects, the one or more animations are based at least in part on the first portion of the data set.

In some aspects, the second orientation is rotated 90 degrees with respect to the first orientation. In some aspects, the data visualization includes a chart representing the first portion of the data set.

In some aspects, the method further includes, prior to presenting the data visualization on the first page, receiving a user selection corresponding to the first portion of the data set, where the data visualization is presented in response to the user selection.

In some aspects, the first portion of the data set includes data from a specified time period. In some aspects, the first portion of the data set includes data from a specified account. In some aspects, the first portion of the data set includes data having a specified transaction type.

Another innovative aspect of the subject matter described in this disclosure can be implemented as a system for transforming a data visualization. An example system includes one or more processors, and a memory storing instructions for execution by the one or more processors. Execution of the instructions by the one or more processors causes the system to perform operations including presenting the data visualization on a first page of a display of the computing device, the data visualization representing at least a first portion of a data set, receiving a visualization transformation command from a user, in response to receiving the visualization transformation command, navigating to a second page of the display, and, during the navigation, transforming the data visualization based at least in part on the first portion of the data set, wherein the transformation includes at least enlarging the data visualization and rotating the data visualization from a first orientation to a second orientation.

Another innovative aspect of the subject matter described in this disclosure can be implemented as a mobile communication device configured for transforming a data visualization. An example mobile communication device includes a touch-sensitive display, one or more processors, and a memory storing instructions for execution by the one or more processors. Execution of the instructions causes the mobile communication device to perform operations including detecting a first touch gesture on the touch-sensitive display selecting a first portion of a data set, in response to detecting the first touch gesture, presenting the data visualization on a first page of the touch-sensitive display, the data visualization representing at least the first portion of the data set, detecting a second touch gesture on the touch-sensitive display, in response to detecting the second touch gesture, navigating to a second page of the display, and, during the navigation, transforming the data visualization based at least in part on the first portion of the data set, including at least enlarging the data visualization and rotating the data visualization from a first orientation to a second orientation.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example illustration 100 showing how a sample page may be provided in either a portrait orientation or a landscape orientation, in accordance with conventional user interface techniques.

FIG. 2 shows an example illustration showing how a graphic item may be maintained or resized in an animation presented while navigating from a first page to a second page, in accordance with conventional user interface tools.

FIG. 3 shows an example data visualization transformation, in accordance with some implementations.

FIG. 4A shows an example illustration 400A of a first page including a data visualization, in accordance with some implementations.

FIG. 4B shows an example illustration showing an in-process transformation of a data visualization, in accordance with some implementations.

FIG. 4C shows another example illustration showing an in-process transformation of a data visualization, in accordance with some implementations.

FIG. 4D shows an example illustration showing a completed transformation of a data visualization, in accordance with some implementations.

FIG. 5 shows a data visualization transformation system, according to some implementations.

FIG. 6 shows an illustrative flow chart depicting an example operation for selectively transforming a first data visualization, according to some implementations.

Like numbers reference like elements throughout the drawings and specification.

### DETAILED DESCRIPTION

Implementations of the subject matter described in this disclosure may be used to provide dynamic transformation of data visualizations as a user navigates between pages of a user interface. More particularly, a data visualization may be presented on the user interface and transformed, based on the data corresponding to the data visualization, as the user navigates from a first page to a second page. The data visualization may remain on the user interface during the transformation and navigation from the first page to the second page. The transformation may include one or more of a rotation, addition or subtraction of layers, addition of animations, and so on. For reference, a “data visualization” refers to any graphic item representing at least a portion of a data set, such as any type of graph, chart, or other visual representation of the portion of the data set. These and other aspects of the example implementations are discussed further below.

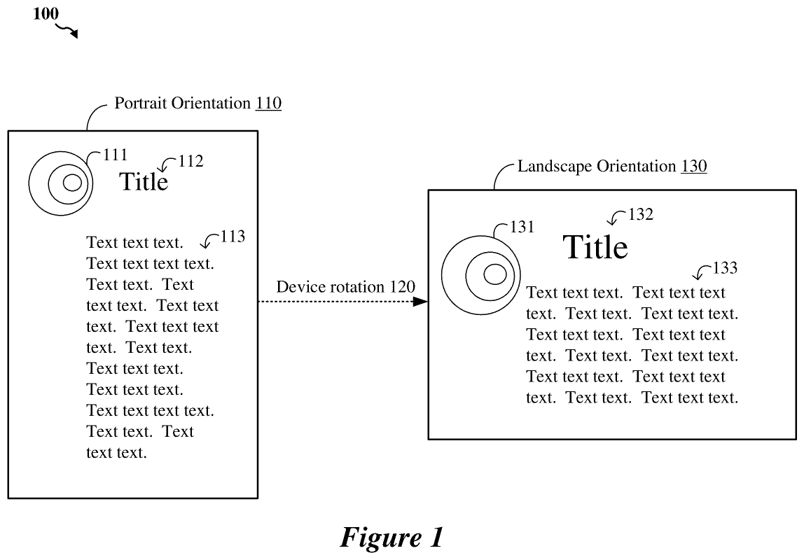

Conventional user interfaces for mobile electronic devices may allow for a display to be presented in two orientations, which may typically be called a portrait orientation and a landscape orientation for conventional rectangular displays. In a portrait orientation the display is taller than it is wide, while in a landscape orientation the display is wider than it is tall. In conventional user interfaces for mobile electronic devices, a user may select whether the display is provided in a portrait or a landscape orientation, such as using one or more selectable interface options. In some other conventional user interfaces, one or more sensors of the mobile electronic device may be used to determine the orientation of the user interface. For example, one or more accelerometers, geomagnetic field sensors, or similar, may determine the orientation. For example, the sensors may detect that a user is holding the mobile electronic device in a portrait orientation, with the display taller than it is wide, or in a landscape orientation, with the display wider than it is tall, and cause the user interface to be provided in that orientation. FIG. 1 shows an example illustration 100 showing how a sample page may be provided in either a portrait orientation or a landscape orientation, in accordance with conventional user interface techniques. FIG. 1 shows a page of a user interface which may be displayed in either a portrait orientation 110 or a landscape orientation 130, and where the user interface may switch between the two orientations in response to detecting a device rotation 120, such as using one or more sensors, such as one or more accelerometers, one or more geomagnetic field sensors, or similar. While presented in the portrait orientation 110, the page is shown to include one or more graphical items 111, a title 112, and body 113. While presented in the landscape orientation 130, the page is shown to include one or more graphical items 131, a title 132, and body 133. The contents of the page in the landscape orientation 130 correspond to the contents of the page in the portrait orientation 110 but may be resized and altered to better fit the selected orientation. For example, the one or more graphical items 131, title 132, and body 133 may be increased in size or moved within the user interface as compared to the one or more graphical items 111, title 112, and body 113. Note that the orientation of the graphical items, title, and body remain consistent with the orientation of the user interface. That is, in the portrait orientation 110, the longer side of the user interface is the vertical axis, and in the landscape orientation 130, the shorter side of the user interface is the vertical axis, but the graphical items, title, and body retain their relative orientation to that vertical axis. For example, the text in the body 133 retains the same orientation from the perspective of the user as the text in the body 113, and the one or more graphical items 131 retain the same orientation from the perspective of the user as the one or more graphical items 111.

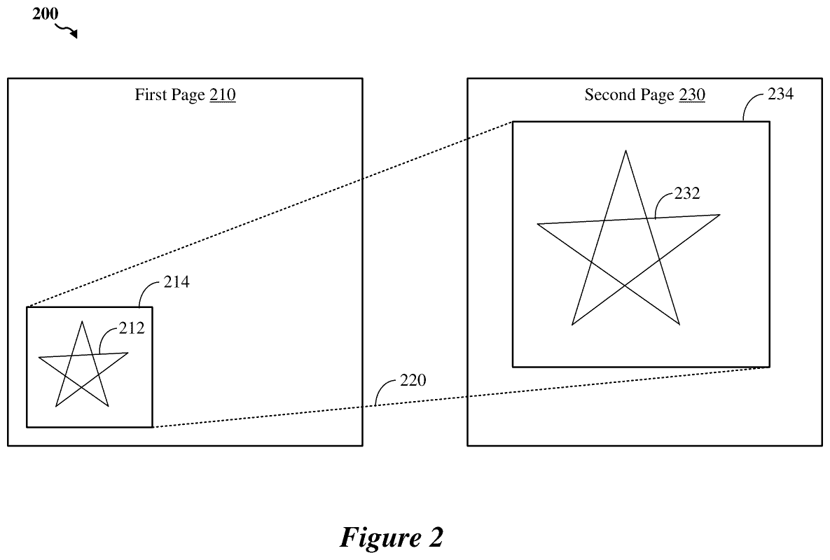

Other conventional user interface tools may allow for a graphic item, such as an image, to be maintained on the user interface while navigating from a first page to a second page. One example of such a user interface tool may be hero animations provided by Flutter, an open-source user interface software development kit (SDK) created by Google. For example, FIG. 2 shows an example illustration 200 showing how a graphic item may be maintained or resized in an animation presented while navigating from a first page to a second page, in accordance with conventional user interface tools. A first graphic item 212 may be presented within a first portion 214 of a first page 210. In response to receiving a command to navigate to a second page 230, the user interface may navigate to the second page while displaying an animation 220. The animation 220 may adjust a size or a position of the first graphic item 212 while navigating to the second page 230, transforming the first graphic item 212 into a second graphic item 232 presented within a second portion 234 of the second page 230. In some aspects, the animation 220 may also result in the second portion 234 having a different shape than the first portion 214. For example, the first portion 214 may be a circular region of the first page 210 containing the first graphic item 212, and the animation 220 may result in the second graphic item 232 being displayed within a rectangular or square second portion 234 of the second page 230. While such conventional user interface tools may allow for a graphic to be maintained or resized on a user interface while navigating from a first page to a second page, they do not present data visualizations, nor can their animations or transformations be related to data underlying such data visualizations.

In contrast to these conventional user interfaces, the example implementations provide users with greater continuity when navigating between pages providing data visualizations relating to the same underlying data by maintaining at least a portion of a data visualization on a user interface while navigating from a first page to a second page. More particularly, a user may navigate from a first page including the data visualization to a second page. During the navigation, the data visualization is transformed while remaining displayed on the user interface. Such transformations are based on the data underlying the first and the second data visualizations, and may include rotating the data visualization from a first orientation to a second orientation, increasing or reducing the size of the data visualization, adding or subtracting of graphical layers to or from the data visualization, the addition of animations, and so on, as discussed in more detail below.

Various implementations of the subject matter disclosed herein provide one or more technical solutions to the technical problem of providing seamless and useful visualizations of data across multiple pages of a user interface. Example implementations may present a data visualization on a first page of a user interface of an electronic device. In response to a user command, the electronic device may navigate to a second page of the user interface while retaining the data visualization on the user interface and transforming the data visualization based its underlying data. For example, the transformation may include rotating the data visualization, such as rotating between a portrait orientation and a landscape orientation, enlarging the data visualization, adding or subtracting one or more layers of the data visualization, adding one or more animations to the data visualization, and so on. Each of the transformations may be based on the data corresponding to the data visualization. More specifically, various aspects of the present disclosure provide a unique computing solution to a unique computing problem that did not exist prior to the development of customizable user interfaces capable of presenting and transforming data visualizations across multiple pages. As such, implementations of the subject matter disclosed herein are not an abstract idea such as organizing human activity or a mental process that can be performed in the human mind.

Moreover, various aspects of the present disclosure effect an improvement in the technical field of customizable data visualizations. The ability to retain a data visualization on a user interface while navigating from a first page to a second page, and transforming the data visualization during the navigation to provide additional information and context relating to the data visualization may provide for better continuity of user experience across the user interface and provide additional information and context to users. For example, preserving all or a portion of a data visualization while navigating to a second page may provide a clear indication of the connectedness of the first page and the second page. Further, transforming the data visualization may allow for the provision of useful information to users, for example by adding layers or animations based on the underlying data in order to better inform users about the underlying data, while also clearly emphasizing how this useful information relates to the original data visualization. Different pages may have differing styles and layouts as well, so allowing the transformation to include rotation and resizing of the data visualization may enable the use of such differing styles and layouts without detracting from the continuity of user experience across pages. Further, rotating the data visualization may enable the data visualization to be enlarged, increasing the visibility of the data visualization, which may be particularly important for mobile electronic devices having small screens. Conventional page transitions may allow for a graphic to be retained across a page transition, but may support only a limited variety of changes, such as changing the size or location of the graphic and may not be capable of the wider variety of transformations supported by the example implementations, much less the data-dependent visualization customizations of the example implementations. Providing configurable data visualizations which may be seamlessly displayed and transformed during page transitions shown on a user interface cannot be performed in the human mind, much less using pen and paper.

Users increasingly use computing devices, particularly mobile computing devices, for reviewing information in a broad variety of contexts. For example, a user may desire to review and analyze statistical information relating to the manufacture of goods within a factory, or to track inventory across a number of stores or warehouses. Similarly, a journalist may wish to present statistical information relating to election polling, or to societal characteristics such as demographics, poverty, income, etc. Similarly, a bank or provider of financial services may provide users with statistics relating to a user's investments or accounts. In each of these scenarios, and many more, it may be beneficial to provide such information in a visual manner, as a data visualization, such as one or more charts, graphs, or other visual information representing the underlying data.

Additionally, particularly with mobile computing devices having relatively small display screens, providing such information in an easy to consume manner may be hampered due to screen size limitations. For example, it may be important to provide such data visualizations in a manner which is easy to discern broad trends in the data, for example as an overview, while also enabling a user to identify relevant details in the data. However, limitations in the screen size of most mobile computing devices may significantly limit the provision of such information on small displays.

Further, such information may often be provided across multiple pages of a user interface. For example, a user interface may display a first page including a first data visualization representing a high level overview of a set of data. If more detailed information is desired, the user may select the first data visualization, or otherwise request the more detailed information, and in response the user interface may display a second page including the detailed analysis relating to the first data visualization and its underlying data. Such a second page may include a second data visualization indicating this more detailed information. However, the lack of continuity between the first page and the second page may make it difficult for the user to identify how the more detailed information in the second data visualization relates to the information from the first data visualization. Therefore, it would be desirable to provide users with greater continuity when navigating between pages providing data visualizations relating to the same underlying data.

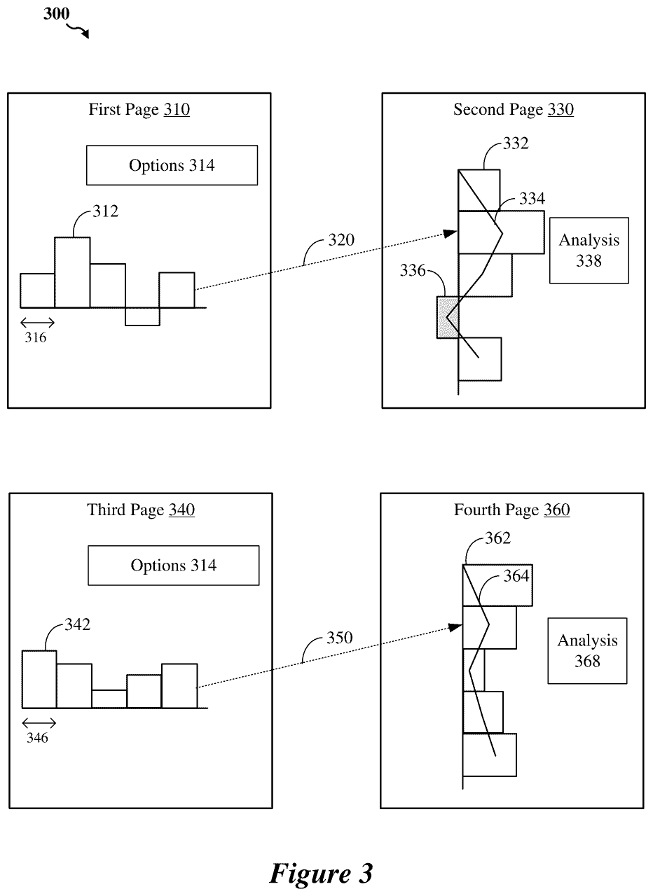

FIG. 3 shows an example data visualization transformation 300, in accordance with some implementations. A first page 310 displays a first data visualization 312. For example, the first data visualization 312 may be based on at least a portion of a data set, such as a data set stored in a memory provided within or coupled to a computing device presenting the first page. In some aspects, the first data visualization 312 may be configured through one or more options 314, which may be selectable or configurable by a user. For example, the options 314 may allow for the configuration or selection of the portion of the data set. That is, the first data visualization 312 may be configured using the options 314, such as by selecting the data used for generating the first data visualization 312, the granularity of the data presented in the first data visualization 312, and so on. In some aspects, the first data visualization 312 may represent the data using a chart, such as a bar chart, a pie chart, using a graph, such as a line graph, and so on. For example, the first data visualization 312 is shown in FIG. 3 to be a bar graph. The options 314 may configure the type of information presented—that is, what the vertical axis of the chart represents—in addition to specifying the categories of information presented—that is, what is represented by the bars of the graph, such as the bar occupying the region 316 of the horizontal axis. For example, when the first data visualization indicates inventory data for one or more warehouses, the options 314 may select a timescale such as by week or by month, for displaying the inventory data, may specify that the first data visualization 312 should display data only for a specific warehouse, and so on. Similarly, when the first data visualization 312 indicates account data associated with one or more accounts of a user, the options 314 may select a timescale for displaying the data, may select a specific account to display data from, a specific transaction type, and so on.

In response to receiving a command to navigate to a second page 330, while the user interface navigates to the second page, the first data visualization 312 may be transformed into a second data visualization 332 via a transformation 320. For example, the command may be received from a user, such as via the user selecting the first data visualization 312 or selecting another option to navigate to the second page 330. The transformation 320 may preserve all or a portion of the first data visualization 312 on the user interface during the transformation 320 while navigating to the second page 330. For example, with respect to FIG. 3, the entire first data visualization 312 may be displayed on the user interface during the transformation 320, while being rotated 90 degrees clockwise, resized, and translated to the location of the second data visualization 332 on the second page 330. Thus, the continuity of the user experience may be maintained during the navigation from the first page 310 to the second page 330, emphasizing the connectedness of subject matter presented on the first page 310 and the second page 330.

In addition to rotations, resizing, and translation, the transformation 320 may implement other alterations to the first data visualization 312 based on the portion of the data set. For example, the second data visualization 332 may include one or more layers than the first data visualization 312, and the transformation 320 may add these one or more layers. With respect to FIG. 3, the second data visualization 332 includes a line 334 representing a moving average or another statistic relating to the portion of the data set. The second data visualization 332 also includes an emphasized bar 336. The emphasized bar 336 may indicate data satisfying one or more criteria. For example, when the second data visualization indicates net income by week, the emphasized bar 336 may indicate a week where the net income is negative, highlighting the week for the user. In such an example, the emphasized bar 336 may be added to the first data visualization 312 during the transformation 320. Further, the second data visualization 332 may include additional analysis 338 not present in the first data visualization 312, and the transformation 320 may add the analysis 338. Note that the line 334, the emphasized bar 336, the analysis 338, and similar additions may be implemented by the transformation 320 as added layers, or as animations. For example, the transformation 320 may add the line 334 as an added layer, such as via fading in the line 334, or may add the line 334 as part of an animation, such as via drawing the line 334 from top to bottom during the transformation 320.

In contrast to the conventional techniques described above with respect to FIG. 1, note that the orientation of the user interface remains unchanged in the first page and the second page. That is, while the transformed data visualization—i.e., the second data visualization 332—is rotated with respect to the first data visualization 312, the orientation of the second page 330 is unchanged with respect to the orientation of the first page 310. Further, when the user interface is presented on a mobile computing device, no rotation of the device is required to cause the transformation of the data visualization, and thus the orientation of the mobile computing device may remain unchanged during the navigation and transformation operations described herein.

In further contrast to the conventional techniques described above, that the alterations implemented by the transformation 320 are all determined based on the portion of the data set underlying the first data visualization 312 and second data visualization 332. If a user alters the first data visualization 312 using the options 314, such as by selecting a different timescale, or selecting a different account or other subset of data for display, that the resulting transformation will be similarly altered. For example, a user may alter the first visualization 312 using the options 314, resulting in the user interface displaying a third page 340. For example, a different subset of data may be selected, or a differing timescale or time window may be selected using the options 314, resulting in display of a third data visualization 342 which is different from the first data visualization 312.

Because selection of different options results in display of a different data visualization, the resulting transformation will also be different, as the transformation depends on the underlying data. For example, in response to receiving a command to navigate to a fourth page 360, the third data visualization 342 may be transformed into a fourth data visualization 362 via a transformation 350.

The moving average of the data shown in the first data visualization 312 may be calculated differently when the first data visualization is changed, as the data underlying the first data visualization has changed, and so the line 364 added by the transformation 350 will similarly be different. With respect to FIG. 3, the fourth data visualization 362 includes a line 364 representing a moving average or another statistic relating to the portion of the data set. Note that the fourth data visualization 362 does not include any emphasized bars. This may be because the one or more criteria are not met in the third data visualization 342. For example, if the criterion is a bar having a value below zero, none of the bars of the third data visualization are negative, and so this criterion is unmet. Further, the fourth data visualization 362 may include additional analysis 368 not present in the third data visualization 342, and the transformation 350 may add the analysis 368. The line 364, the analysis 368, and similar additions may also be implemented by the transformation 350 as added layers, or as animations.

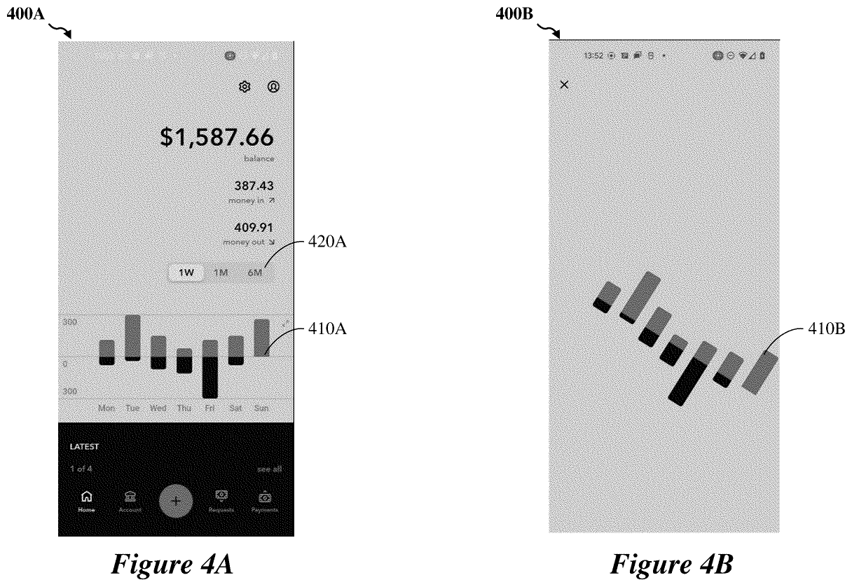

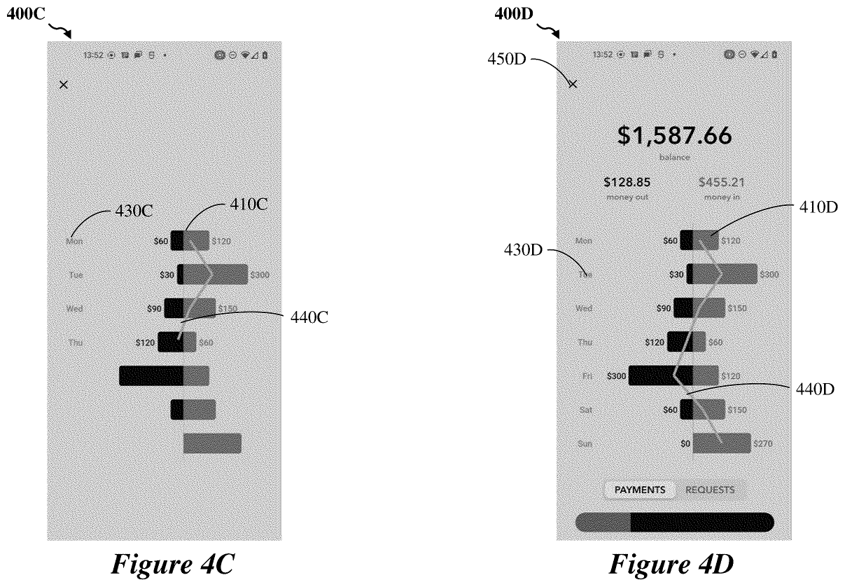

FIGS. 4A-4D illustrate in more detail an example transformation of a data visualization during a page transition, in accordance with some implementations. More particularly, FIG. 4A shows an example illustration 400A of a first page including a data visualization, in accordance with some implementations. More particularly, FIG. 4A shows a data visualization 410A indicating money in and money out of a specified account, where money in is represented by the lighter bars above the zero line, and money out is represented by the darker bars below the zero line. The data visualization 410A may be one example of the first data visualization 312 of FIG. 3. FIG. 4A also shows options 420A, corresponding to options 314 of FIG. 3, representing selectable options for configuring the data visualization 410A to show data over a specified time period, such as over one week (“1W”), one month (“1M”) or six months (“6M”). In response to a user selection, such as a touch gesture performed by a user on a region of the user interface including the data visualization 410, a navigation to a second page, and a transformation of the data visualization 410A, may be triggered.

FIG. 4B shows an example illustration 400B showing an in-process transformation of a data visualization, in accordance with some implementations. More particularly, FIG. 4B depicts a user interface at a point in time subsequent to the point in time depicted in FIG. 4A, and subsequent to the user selection. In FIG. 4B, a portion of the data visualization 410A remains presented on the display as data visualization 410B, but much of the data shown on the display in FIG. 4A is removed, for example, the options 420A have been removed, in addition to layers of the data visualization 410A indicating times and amounts have been removed. Further, in the transformation depicted in FIGS. 4A-4D, the data visualization 410B is in the process of being rotated and enlarged, as compared to the data visualization 410A.

FIG. 4C shows another example illustration 400C showing an in-process transformation of a data visualization, in accordance with some implementations. More particularly, FIG. 4C depicts the user interface at a point in time subsequent to the point in time depicted in FIG. 4C. In FIG. 4C, the data visualization 410C has been rotated 90 degrees and enlarged with respect to data visualization 410A. Further, one or more layers 430C are in the process of being added, such as the times corresponding to the bars of the data visualization 410C, and the amounts in money in and money out corresponding to each bar. These layers may be animated, as shown in-progress in FIG. 4C, with the days Monday-Thursday added, but Friday-Sunday yet to be added. Further another animation adding a line 440C is in process at the point in time shown in FIG. 4C, where the line 440C represents the net cashflow and is in the process of being drawn.

FIG. 4D shows an example illustration 400D showing a completed transformation of a data visualization, in accordance with some implementations. FIG. 4D shows the user interface after the transformation depicted in FIGS. 4B and 4C has been completed, and the user interface has navigated to the second page. The data visualization 410D remains on the user interface, having been enlarged and rotated, and the one or more layers 430D have been added—note that the remaining days and dollar amounts in the one or more layers 430D have been completed, as compared to the one or more layers 430C. Additionally, the animation adding the line 440D has completed, and the net cashflow is indicated on the data visualization 410D for the entire week.

Note that while FIG. 3 and FIGS. 4A-4D depict navigation from the first page to the second page, that in some other implementations, the process may be reversed. That is, for example, a user interface may display the contents of FIG. 4D, including the data visualization 410D, the one or more layers 430D, and the line 440D, and a command may be received to navigate back to the first page depicted in FIG. 4A. For example, the command may be a user selection of the “X” 450D shown in FIG. 4D. In response to the user selection, the user interface may proceed from the illustration 400D to the illustrations 400C and 400A, reversing the transformation to return the user interface to appear as shown in FIG. 4A. That is, the navigation and transformation operations of the example implementations may proceed from the first page to the second page, or from the second page back to the first page.

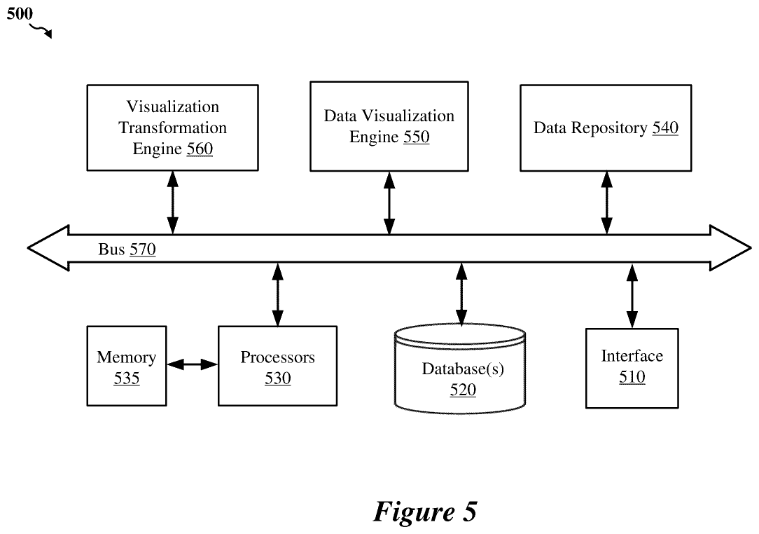

FIG. 5 shows a data visualization transformation system 500, according to some implementations. Various aspects of the data visualization transformation system 500 disclosed herein may be applicable for transforming data visualizations during navigation between pages of a user interface in a variety of computing applications. Such functionality may be useful for providing users with a continuity of user experience across pages, in addition to providing more useful visualization of the data through the addition of layers and animations based on the underlying data of the visualization, as well as supporting navigation to pages having differing layouts and formats by enabling the data visualization to be transformed into a format and appearance better suited to the destination page while maintaining the presence of the data visualization on the user interface.

The data visualization transformation system 500 is shown to include an input/output (I/O) interface 510, a database 520, one or more data processors 530, a memory 535 coupled to the data processors 530, a data repository 540, a data visualization engine 550, and a visualization transformation engine 560. In some implementations, the various components of the data visualization transformation system 500 may be interconnected by at least a data bus 570, as depicted in the example of FIG. 5. In other implementations, the various components of the data visualization transformation system 500 may be interconnected using other suitable signal routing resources.

The interface 510 may include a screen, an input device, and other suitable elements that allow a user to provide information to the data visualization transformation system 500 and/or to retrieve information from the data visualization transformation system 500. Example information that can be provided to the data visualization transformation system 500 may include configuration information for the data visualization transformation system 500, such as information for configuring the module repository 540, module customization engine 550, or layout generation engine 560, user commands to navigate between pages or to select or configure data visualizations displayed using the data visualization transformation system 500, new data to be added to the data repository 540, and so on. Example information that can be retrieved from the data visualization transformation system 500 may include data retrieved from the data repository 540, for example via one or more networks coupled to the data visualization transformation system 500, data visualizations generated by the data visualization transformation system 500, and the like.

The database 520, which may represent any suitable number of databases, may store any suitable information pertaining to configuration of the data visualization transformation system 500, or to users of the data visualization transformation system 500. For example, the information may include configuration information for managing enablement or customization associated with data or data visualizations, and so on. In some implementations, the database 520 may be a relational database capable of presenting the information as data sets to a user in tabular form and capable of manipulating the data sets using relational operators. In some aspects, the database 520 may use Structured Query Language (SQL) for querying and maintaining the database 520.

The data processors 530, which may be used for general data processing operations (such as manipulating the data sets stored in the data repository 540), may be one or more suitable processors capable of executing scripts or instructions of one or more software programs stored in the data visualization transformation system 500 (such as within the memory 535). The data processors 530 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the data processors 530 may be implemented as a combination of computing devices (such as a combination of a DSP and a microprocessor, a plurality of microprocessors, one or more microprocessors in conjunction with a DSP core, or any other such configuration).

The memory 535, which may be any suitable persistent memory (such as non-volatile memory or non-transitory memory) may store any number of software programs, executable instructions, machine code, algorithms, and the like that can be executed by the data processors 530 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The data repository 540 may store one or more data sets from which data visualizations may be generated by the data visualization transformation system 500. As discussed above, each data visualization may be based on data from the one or more data sets and may be generated based on selectable portions of the data, such as based on data from a selected account or user, from a selected timeframe, and so on.

The data visualization engine 550 may generate data visualizations based on data from the data repository 540. For example, a data visualization may be generated based on a specified portion of a data set from the data repository 540, according to one or more configurations. As discussed above, the specified portion may be determined in response to input provided by a user, such as via the interface 510, via a touch gesture on a touch-sensitive display coupled to the data visualization transformation system 500, and so on. Such a specified portion may include data corresponding to specified accounts, users, timeframes, purposes, transaction types, locations, or any suitable organizing characteristic of the data in the data set. The data visualization engine 550 may generate the data visualization according to one or more configurations. Such configurations may include visualization type, such as a bar graph, line graph, or any other suitable data visualization type, one or more colors or patterns for displaying the data visualization, one or more orientations, such as a vertical or a horizontal orientation, and so on.

The visualization transformation engine 560 may transform data visualizations generated by the data visualization engine 550 during transitions between pages displayed on a user interface coupled to the data visualization transformation system 500, such as displayed via the interface 510. More particularly, during a transition from a first page of the user interface to a second page of the user interface, the visualization transformation engine 560 may transform a data visualization presented on the first page during a navigation to the second page, where the transformation enlarges and rotates the data visualization from a first orientation to a second orientation. That is, at least portion of the first data visualization is retained during the transformation and continues to be presented on the user interface during the transformation and navigation, while the data visualization is enlarged and rotated from a first orientation to a second orientation. For example, the bar graph depicted as the data visualization 410A continues to be presented on the user interface during the transformation depicted in FIGS. 4A-4D as the data visualization 410B, 410C, and 410D. As discussed above, the transformations generated by the visualization transformation engine 560 may include one or more rotations, one or more resizing operations, add or subtract layers, add animations, and so on. The transformations may be based upon the data underlying the first and second data visualizations.

The particular architecture of the data visualization transformation system 500 shown in FIG. 5 is but one example of a variety of different architectures within which aspects of the present disclosure may be implemented. For example, in other implementations, the data visualization transformation system 500 may not include the module repository 540, the functions of which may be implemented by the processors 530 executing corresponding instructions or scripts stored in the memory 535. In further implementations, all, or part of the module repository 540 may not be located within the data visualization transformation system 500 but may instead be coupled to the data visualization transformation system 500 via one or more network resources. In some other implementations, the functions of the module customization engine 550 may be performed by the processors 530 executing corresponding instructions or scripts stored in the memory 535. Similarly, the functions of the layout generation engine 560 may be performed by the processors 530 executing corresponding instructions or scripts stored in the memory 535.

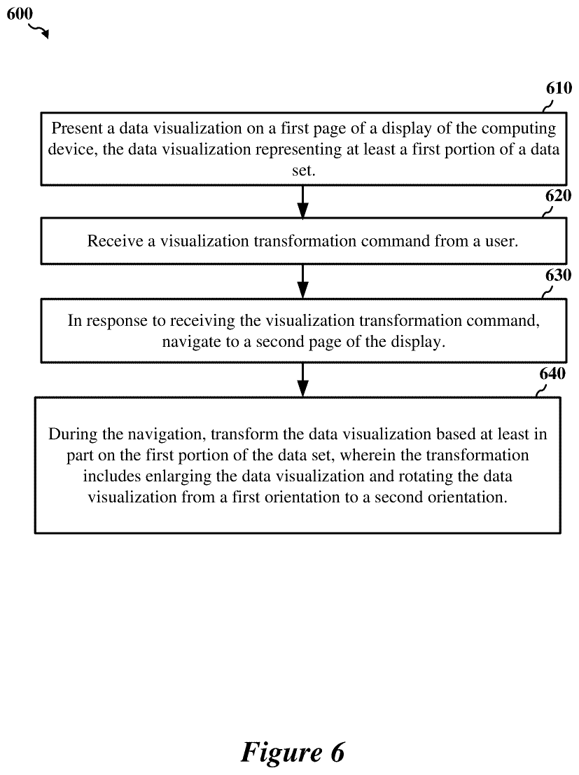

FIG. 6 shows an illustrative flow chart depicting an example operation 600 for transforming a data visualization, according to some implementations. The example operation 600 may be performed by one or more processors of a computing device such as the data visualization transformation system 500 of FIG. 5. It is to be understood that the example operation 600 may be performed by any suitable systems, computers, or servers.

At block 610, the data visualization transformation system 500 presents a data visualization on a first page of a display, the data visualization representing at least a first portion of a data set. At block 620, the data visualization transformation system 500 receives a visualization transformation command from a user. In response to receiving the visualization transformation command, at block 630 the data visualization transformation system 500 navigates to a second page of the display. At block 640, during the navigation, the data visualization transformation system 500 transforms the data visualization based at least in part on the first portion of the data set, the transformation enlarging and rotating the data visualization from a first orientation to a second orientation.

In some aspects, the transforming in block 640 includes adding one or more layers to the data visualization. In some aspects, the one or more added layers are based at least in part on the first portion of the data set. In some aspects, the transforming in block 640 includes adding one or more animations to the data visualization, the one or more animations absent from the data visualization presented on the first page. In some aspects, the one or more animations are based at least in part on the first portion of the data set.

In some aspects, the first page and the second page share a common orientation. In some aspects, the second orientation is rotated 90 degrees with respect to the first orientation.

In some aspects, the data visualization includes a chart representing the first portion of the data set.

In some aspects, the operation 600 further includes, prior to presenting the data visualization on the first page, receiving a user selection corresponding to the first portion of the data set, where the data visualization is presented in response to the user selection.

In some aspects, the first portion of the data set includes data from a specified time period. In some aspects, the first portion of the data set includes data from a specified account. In some aspects, the first portion of the data set includes data having a specified transaction type.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

1. A method for transforming a data visualization during a page navigation, the method performed by one or more processors of a computing device and comprising:
presenting the data visualization on a first page of a display of the computing device, the first data visualization representing at least a first portion of a data set;
receiving a visualization transformation command from a user;
in response to receiving the visualization transformation command, navigating to a second page of the display; and
during the navigation to the second page, transforming the data visualization based at least in part on the first portion of the data set, wherein the transformation includes animating an enlargement of the data visualization by a predetermined proportion and a rotation of the data visualization from a first orientation to a second orientation orthogonal to the first orientation without changing an orientation of the display of the computing device or an orientation of the first page or the second page.

2. The method of claim 1, wherein the first page and the second page share a common orientation.

3. The method of claim 1, wherein the transformation comprises adding one or more layers to the data visualization.

4. The method of claim 3, wherein the added one or more layers are based at least in part on the first portion of the data set.

5. (canceled)

6. The method of claim 1, wherein the animating is based at least in part on the first portion of the data set.

7. (canceled)

8. The method of claim 1, wherein the data visualization comprises a chart representing the first portion of the data set.

9. The method of claim 1, further comprising, prior to presenting the data visualization on the first page, receiving a user selection corresponding to the first portion of the data set, wherein the data visualization is presented in response to the user selection.

10. The method of claim 1, wherein the first portion of the data set comprises data from a specified time period.

11. The method of claim 1, wherein the first portion of the data set comprises data from a specified account.

12. The method of claim 1, wherein the first portion of the data set comprises data having a specified transaction type.

13. The method of claim 1, wherein the computing device is a mobile computing device, and wherein an orientation of the mobile computing device remains unchanged during the navigation and transformation.

14. A system for transforming a data visualization, comprising:
one or more processors; and
a memory storing instructions that, when executed by the one or more processors, cause the system to perform operations comprising:
presenting the data visualization on a first page of a display of the computing device, the first data visualization representing at least a first portion of a data set;
receiving a visualization transformation command from a user;
in response to receiving the visualization transformation command, navigating to a second page of the display; and
during the navigation to the second page, transforming the data visualization based at least in part on the first portion of the data set, wherein the transformation includes animating an enlargement of the data visualization by a predetermined proportion and a rotation of the data visualization from a first orientation to a second orientation orthogonal to the first orientation without changing an orientation of the display of the computing device or an orientation of the first page or the second page.

15. The system of claim 14, wherein the first page and the second page share a common orientation.

16. The system of claim 14, wherein the transformation comprises adding one or more layers to the data visualization.

17. The system of claim 14, wherein the animating is based at least in part on the first portion of the data set.

18. (canceled)

19. The system of claim 14, further comprising, prior to presenting the data visualization on the first page, receiving a user selection corresponding to the first portion of the data set, wherein the data visualization is presented in response to the user selection.

20. A mobile communication device for transforming a data visualization, comprising:
a touch-sensitive display;
one or more processors; and
a memory storing instructions that, when executed by the one or more processors, cause the mobile communication device to perform operations comprising:
detecting a first touch gesture on the touch-sensitive display selecting a first portion of a data set;
in response to detecting the first touch gesture, presenting the data visualization on a first page of the touch-sensitive display, the data visualization representing at least the first portion of a data set;
detecting a second touch gesture on the touch-sensitive display; and
in response to detecting the second touch gesture, navigating to a second page of the display, and, during the navigation, transforming the data visualization based at least in part on the first portion of the data set, wherein the transformation includes animating an enlargement of the data visualization by a predetermined proportion and a rotation of the data visualization from a first orientation to a second orientation orthogonal to the first orientation without changing an orientation of the display of the computing device or an orientation of the first page or the second page.
